(19) United States
(12) Patent Application Publication
(10) Pub. No.: US 2020/0155994 A1
(43) Pub. Date: May 21, 2020

(54) Self-cleaning air filter and control system thereof

(71) Applicant: Zhejiang Haanyo Intelligence Technology Co., Ltd, Lanxi (CN)

(72) Inventors: Zhicheng Xu, Wuxi (CN); Xiaoli Tang, Wuxi (CN); Lin Chen, Yangzhou (CN)

(73) Assignee: Zhejiang Haanyo Intelligence Technology Co., Ltd

(21) Appl. No.: 16/749,984

(22) Filed: Jan. 22, 2020

(30) Foreign Application Priority Data
Jan. 28, 2019 (CN) 201910078054.2

(51) Int. Cl. B01D 46/48; B01D 46/04

(52) U.S. Cl. CPC B01D 46/48; F16K 31/0675; B01D 46/04

(57) ABSTRACT

A self-cleaning air filter has a reasonable structure, including a shell, wherein an air inlet is provided on the shell; an air filter end cap is installed on a top cover at a first end of the shell, and an air bag is fixed in the shell; a filter outlet is provided inside the shell; a main filter element is installed in the shell, wherein one end of the main filter element presses against an external portion of the air bag to form a sealed connection; a space between an external wall of the filter outlet and an internal wall of the shell forms an air channel; an air storage part of the air bag is arranged around the filter outlet; an output of the air storage part of the air bag is connected to an input end of an electromagnetic pulse valve.

### CROSS REFERENCE OF RELATED APPLICATION

The present invention claims priority under 35 U.S.C. 19(a-d) to CN 201910078054.2, filed Jan. 28, 2019.

### BACKGROUND OF THE PRESENT INVENTION

### Field of Invention

The present invention relates to a technical field of air filter structures, and more particularly to a self-cleaning air filter and a control system thereof.

### Description of Related Arts

The air filter is a filtering structure that cleans the outside air and transmits it to the inside. For internal combustion engine vehicles, air filter is a device that separates and filters out particles in the atmosphere and provides clean air to the internal combustion engine. The conventional air filter has a short maintenance interval, maintenance process of the filter element is complicated, and the structure is complicated, which will cause a long downtime of vehicle or equipment, leading to high costs of use and maintenance of the entire air filter.

Chinese patent CN108397318A disclosed a self-cleaning air filter, which uses an airflow jetted by a pulsed airflow to clean accumulated dust on an external surface with of the air filter element. The airflow jetted from an air bag passes from inside to outside, and directly reaches the space inside the air filter element. However, due to the large space inside the air filter element, the impact of the jetted airflow on the air filter element cannot reach an ideal level. Therefore, the actual ability to clean up the dust on the external surface of the filter element is not satisfactory.

### SUMMARY OF THE PRESENT INVENTION

An object of the present invention is to provide a self-cleaning air filter with reasonable structure, which can clean up dust accumulated on an external surface of an air filter element, wherein a self-cleaning effect is sufficient, a service life of the air filter element is prolonged, and a use cost of the air filter element is reduced. The present invention also provides a control system of the self-cleaning air filter.

Accordingly, the present invention provides a self-cleaning air filter, comprising: a shell, wherein the shell is a cylindrical body with two opened ends; at least one air inlet is provided on an external circumferential surface of the shell; an air filter end cap is installed on a top cover at a first end in a length direction of the shell, and an air bag is fixed at a second end in the length direction of the shell; a filter outlet is provided inside the second end in the length direction of the shell; a main filter element is installed in the shell, wherein the main filter element is a ring-shaped filter element and is tightly installed in the shell through the air filter end cap; one end in a length direction of the main filter element presses against an external portion of the air bag to form a sealed connection; air enters from the air inlet to be filtered by the main filter element, and then is discharged from the filter outlet; a space between an external wall of the filter outlet and an internal wall of the shell forms an air channel; an air storage part of the air bag is arranged around the filter outlet; an output of the air storage part of the air bag is connected to an input end of an electromagnetic pulse valve, and an output end of the electromagnetic pulse valve communicates with an air inlet end of the air channel; an air outlet end of the air channel is located inside the main filter element; a dust discharge hole is provided on an external circumferential surface of the air filter end cap; compressed air stored in the air storage part of the air bag sequentially passes through the electromagnetic pulse valve and the air channel before being blown to the main filter element to remove dust on the main filter element and discharge the dust from the dust discharge hole.

Preferably, one side of the air inlet end of the air channel is provided with a guide groove corresponding to the output end of the electromagnetic pulse valve, to guide the compressed air in the air storage part of the air bag.

Preferably, a deflector is provided at the air outlet end of the air channel, and the deflector is arranged along a circumferential direction of the filter outlet.

Preferably, the deflector comprises an annular portion and an opening provided at a tail end of the annular portion; an included angle between the opening and the annular portion ranges from 0 degree to 80 degrees.

Preferably, a safety filter element is provided in the shell and located inside the main filter element; the safety filter element is a ring-shaped filter element and is tightly installed in the shell through the air filter end cap; an end in a length direction of the safety filter element, which is away from the air filter end cap, presses against the filter outlet to form a sealed connection.

Preferably, a safety filter element is provided in the shell and located inside the main filter element; the safety filter element is installed at an air inlet end of the filter outlet, wherein the safety filter element is a flat filter element matching the air inlet end of the filter outlet.

Preferably, a discharge valve is provided at a bottom of the air storage part of the air bag.

Preferably, an air inlet is provided at the air storage part of the air bag, and a valve is provided at the air inlet of the air bag.

Preferably, the valve is a differential pressure check valve.

Preferably, a first sealing ring is provided on one end surface of the main filter element for cooperating with an external surface of the air bag to form a radial seal connection.

Preferably, a second sealing ring is provided on an internal surface of one end of the main filter element for cooperating with an external bottom surface of the air bag to form an axial seal connection.

Preferably, a first sealing ring is provided on one end surface of a safety filter element for cooperating with the filter outlet to form a radial seal connection.

Preferably, a second sealing ring is provided on an internal surface of one end of a safety filter element for cooperating with a deflector to form an axial seal connection.

Preferably, the dust discharge hole is provided at a bottom of the shell.

Preferably, a dust discharge valve is provided in the dust discharge hole, which comprises an internal hole and an external hole provided outside the internal hole; the dust discharge valve is made of an elastic material; the dust discharge valve further comprises a columnar portion having a size matching the internal hole; a hook portion is provided on the columnar portion, which restricts the columnar portion after being inserted into the internal hole, thereby preventing the dust discharge valve from detaching; an umbrella cap portion is connected to a tail end of the columnar portion, which covers the external hole.

Preferably, the external hole comprises multiple holes arranged around and outside the internal hole.

Preferably, the shell is provided with an air inlet baffle facing the air inlet; the air inlet baffle is fixed on the shell by screws or rivets.

Preferably, the air filter end cap is fixed to the shell by a buckle.

A control system of a self-cleaning air filter is also provided, comprising a controller which is electrically connected to an electromagnetic pulse valve, wherein the controller is also electrically connected to a vehicle battery and a trigger device; the vehicle battery is used for power supply, and the trigger device is used to provide a trigger signal for the electromagnetic pulse valve.

Preferably, the trigger device comprises a vehicle key ignition switch.

Preferably, the trigger device comprises an air intake resistance sensor, and the air intake resistance sensor is screwed into the filter outlet.

Preferably, the trigger device comprises a self-reset button switch.

Preferably, the controller is a single-chip microcomputer AtMega328p.

Preferably, the controller is a relay.

According to the present invention, the self-cleaning air filter, the filter outlet is provided in shell of the air filter, in such a manner that the space between the external wall of the filter outlet and the internal wall of the shell forms the air channel. The compressed air in the air bag sequentially passes through the electromagnetic pulse valve and the air channel before being blown to the main filter element to remove dust on the main filter element and discharge the dust from the dust discharge hole. The compressed air is blown to the main filter element through the air channel formed by the narrow space, which generates a large impact on the air filter element, in such a manner that the dust on the external surface of the air filter element is well cleaned, a self-cleaning effect is sufficient, a service life of the air filter element is prolonged, and a use cost of the air filter element is reduced. One side of the air inlet end of the air channel is provided with the guide groove corresponding to the output end of the electromagnetic pulse valve, to guide the compressed air in the air storage part of the air bag. At the same time, the deflector is provided at the air outlet end of the air channel, and the deflector is arranged along the circumferential direction of the filter outlet. The guide groove and the deflector can reduce pressure loss and maximize a blowing effect. The air bag is placed inside the air filter and is integrated with the air filter, providing easy installation and reasonable structure. The safety filter element is provided in the shell and located inside the main filter element to further ensure the filtering effect of the air filter.

### BRIEF DESCRIPTION OF THE DRAWINGS

FIG. 1 is a sketch view of a self-cleaning air filter of the present invention;

FIG. 2 is a cross-sectional view of the self-cleaning air filter of the present invention;

FIG. 3 is an exploded view of the self-cleaning air filter of the present invention;

FIG. 4 is a cross-sectional view of arrangement of a safety filter according to an embodiment of the present invention;

FIG. 5 is a sketch of a sealing structure between a main filter element, a safety filter element and a shell according to the embodiment of the present invention;

FIG. 6 is a sketch of the sealing structure between the main filter element, the safety filter element and the shell according to another embodiment of the present invention;

FIG. 7 is a sketch of the sealing structure between the main filter element, the safety filter element and the shell according to one embodiment of the present invention;

FIG. 8 is a cross-sectional view of a dust discharge hole and a dust discharge valve of the present invention;

FIG. 9 illustrates an air filtering flow of the self-cleaning air filter of the present invention;

FIG. 10 illustrates a compressed air blowing flow of the self-cleaning air filter of the present invention.

### DETAILED DESCRIPTION OF THE PREFERRED EMBODIMENT

The technical solutions in the embodiments of the present invention will be clearly and completely described with the accompanying drawings. Obviously, the described embodiments are only a part of all possible embodiments of the present invention. Based on the described embodiments of the present invention, all other embodiments obtained by those of ordinary skill in the art without creative efforts shall fall within the protection scope of the present invention.

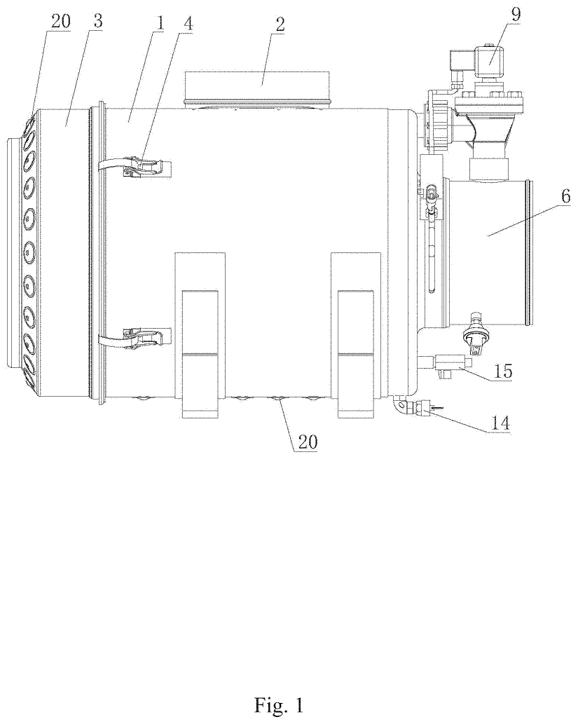

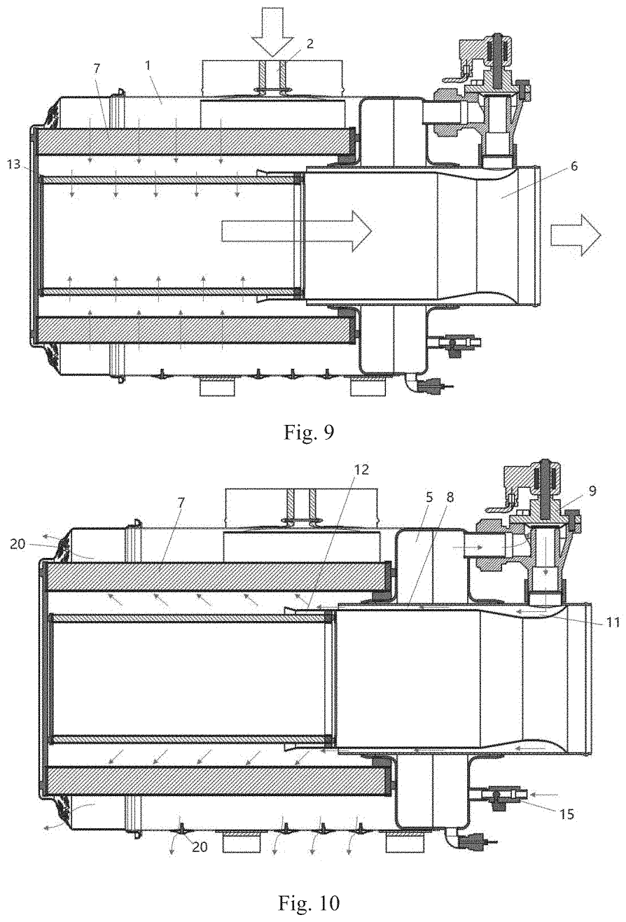

Referring to FIGS. 1-3, a self-cleaning air filter comprises: a shell 1, wherein the shell 1 is a cylindrical body with two opened ends; according to the embodiment, one air inlet 2 is provided on an external circumferential surface of the shell 1; an air filter end cap 3 is installed on a top cover at a first end in a length direction of the shell 1; according to the embodiment, the air filter end cap 3 is fixed to the shell 1 by a buckle 4; an air bag 5 is fixed at a second end in the length direction of the shell 1; a filter outlet 6 is provided inside the second end in the length direction of the shell 1; a main filter element 7 is installed in the shell 1, wherein the main filter element 7 is a ring-shaped filter element and is tightly installed in the shell 1 through the air filter end cap 3; one end in a length direction of the main filter element 7 presses against an external portion of the air bag 5 to form a sealed connection; referring to FIG. 9, arrows illustrate air filtering flow directions, wherein air enters from the air inlet 2 to be filtered by the main filter element 7, and then is discharged from the filter outlet 6; a space between an external wall of the filter outlet 6 and an internal wall of the shell 1 forms an air channel 8; an air storage part of the air bag 5 is arranged around the filter outlet 6; an output of the air storage part of the air bag 5 is connected to an input end of an electromagnetic pulse valve 9, and an output end of the electromagnetic pulse valve 9 communicates with an air inlet end of the air channel 8; an air outlet end of the air channel 8 is located inside the main filter element 1; a dust discharge hole 10 is provided on an external circumferential surface of the air filter end cap 3; referring to FIG. 10, arrows illustrate compressed air flow directions, wherein compressed air stored in the air storage part of the air bag 5 sequentially passes through the electromagnetic pulse valve 9 and the air channel 8 before being blown to the main filter element 7 to remove dust on the main filter element 7 and discharge the dust from the dust discharge hole 10.

Preferably, one side of the air inlet end of the air channel 8 is provided with a guide groove 11 corresponding to the output end of the electromagnetic pulse valve 9, to guide the compressed air in the air storage part of the air bag 5. Meanwhile, a deflector 12 is provided at the air outlet end of the air channel 8, and the deflector 12 is arranged along a circumferential direction of the filter outlet 6. The deflector 12 comprises an annular portion 121 and an opening 122 provided at a tail end of the annular portion 121; an included angle between the opening 122 and the annular portion 121 ranges from 0 degree to 80 degrees. The guide groove 11 and the deflector 12 can reduce pressure loss and maximize a blowing effect.

Preferably, a discharge valve 14 is provided at a bottom of the air storage part of the air bag 5 for manually water and pressure. According to the embodiment, the discharge valve 14 is connected to the air bag 5 through a screw thread.

Preferably, an air inlet is provided at the air storage part of the air bag 5, and a valve 15 is provided at the air inlet of the air bag 5. According to the embodiment, the valve 15 is a differential pressure check valve, which is connected to a vehicle air source for balancing a pressure between the air bag 5 and the vehicle air source. An internal pressure of the air bag is typically 0.1 MPa to 1.0 MPa. When the air bag 5 lacks pressure, the vehicle air source automatically replenishes the air bag 5, or the air source can be manually cut off. According to the embodiment, the air inlet is connected to the air bag 5 by a screw thread.

Preferably, the shell 1 is provided with an air inlet baffle 21 facing the air inlet 2; the air inlet baffle 21 is fixed on the shell 1 by screws or rivets to prevent impurities in air from directly impacting the main filter element 7 during air intake. When the compressed air in the air bag recoils, the air inlet baffle 21 will pop up and seal the air inlet 2 under air pressure, thereby forming a temporary sealed cavity with the shell 1 of the air filter and generating a positive pressure, so that the dust on the main filter element 7 manages to open the dust discharge valve with the compressed air before being discharged from the dust discharge hole.

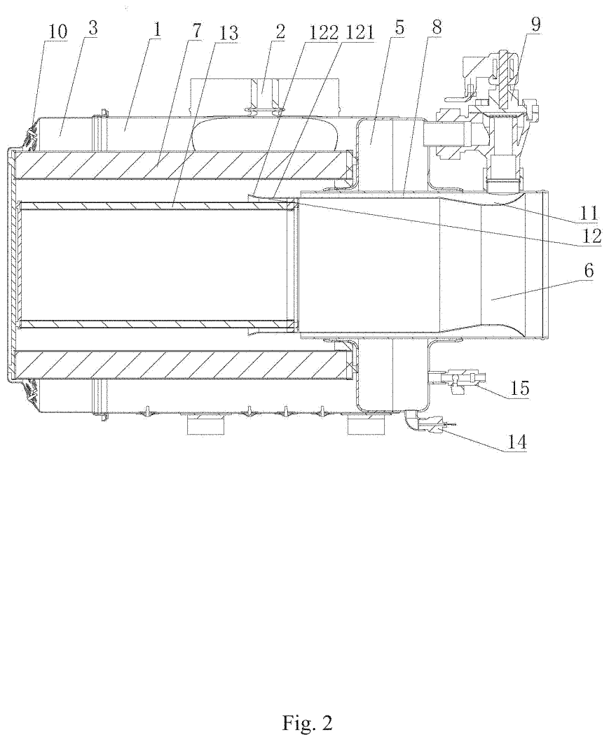

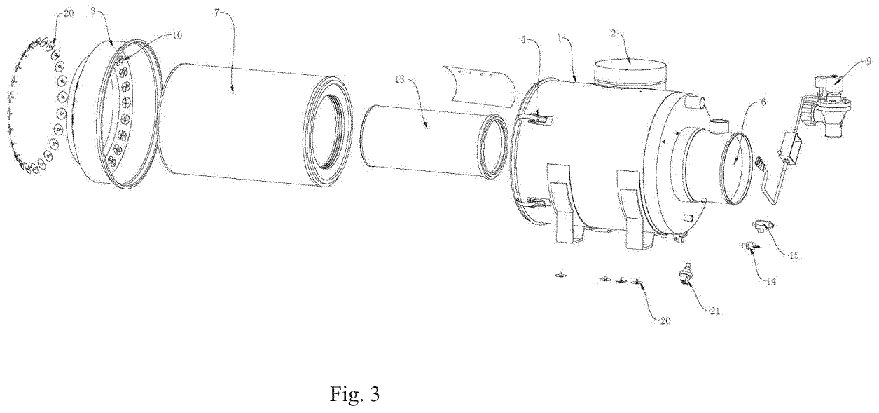

Referring to FIGS. 2 and 3, according to one embodiment of the present invention, a safety filter element 13 is provided in the shell 1 and located inside the main filter element 7; the safety filter element 12 is a ring-shaped filter element and is tightly installed in the shell 1 through the air filter end cap 3; an end in a length direction of the safety filter element 13, which is away from the air filter end cap 3, presses against the filter outlet 6 to form a sealed connection.

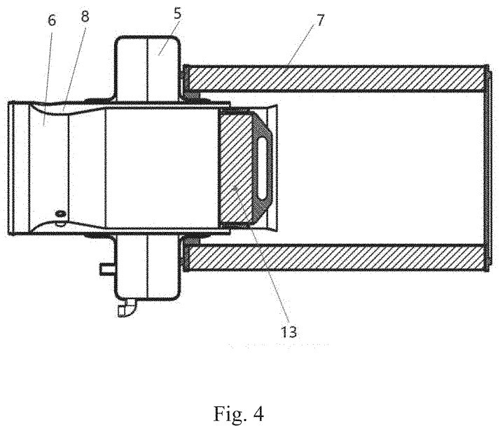

Referring to FIG. 4, according to another embodiment of the present invention, a safety filter element 13 is provided in the shell 1 and located inside the main filter element 7; the safety filter element 13 is installed at an air inlet end of the filter outlet 6, wherein the safety filter element 13 is a flat filter element matching the air inlet end of the filter outlet 6.

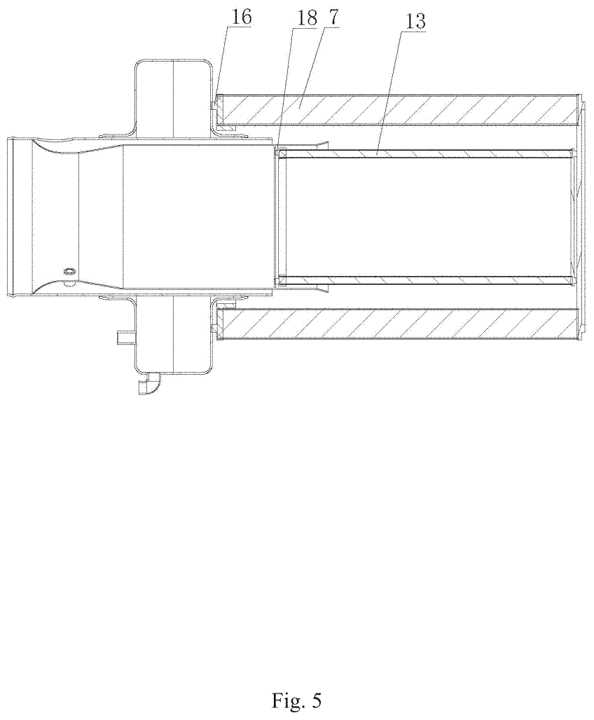

Referring to FIG. 5, according to one embodiment of the present invention, a first sealing ring 16 is provided on one end surface of the main filter element 7 for cooperating with an external surface of the air bag 5 to form a radial seal connection.

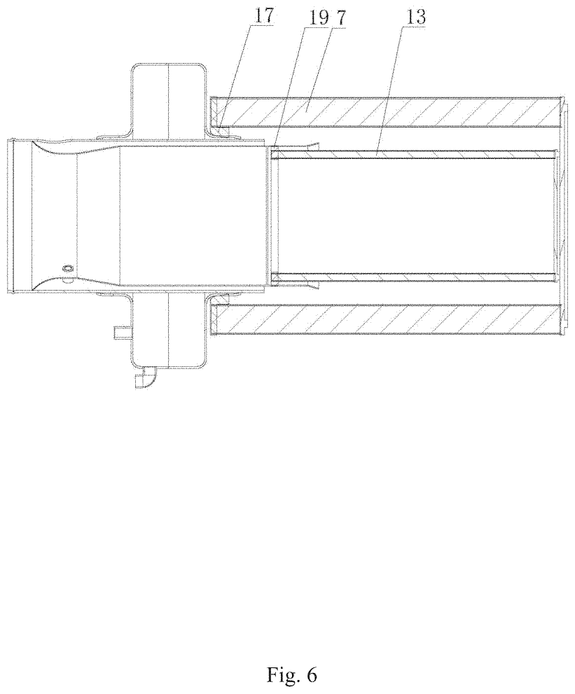

Referring to FIG. 6, according to one embodiment of the present invention, a second sealing ring 17 is provided on an internal surface of one end of the main filter element 7 for cooperating with an external bottom surface of the air bag 5 to form an axial seal connection.

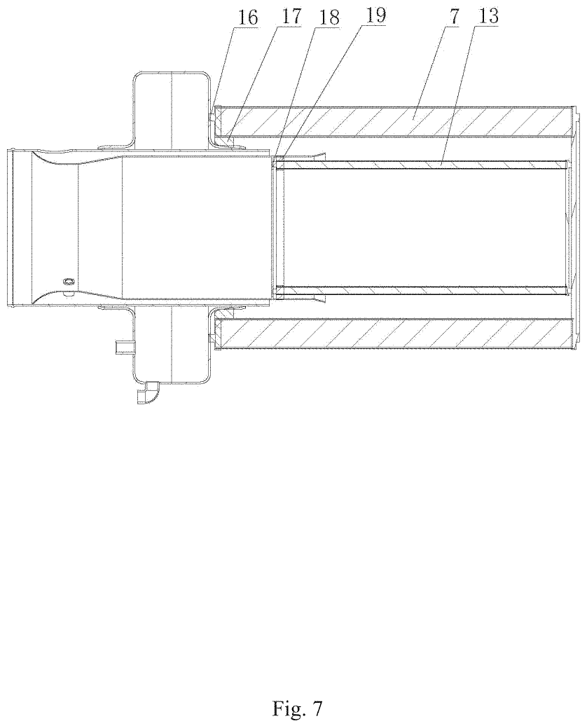

Referring to FIG. 7, according to one embodiment of the present invention, a first sealing ring 16 is provided on one end surface of the main filter element 7, and a second sealing ring 17 is provided on an internal surface of one end of the main filter element 7. The first sealing ring 16 cooperates with an external surface of the air bag 5 to form a radial seal connection, and the second sealing ring 17 cooperates with an external bottom surface of the air bag 5 to form an axial seal connection. The axial and radial seal connections ensure that the air pass through the main filter element 7 before being discharged form the filter outlet 6, thereby ensuring the filtering effect.

Referring to FIG. 5, according to one embodiment of the present invention, a first sealing ring 18 is provided on one end surface of a safety filter element 13 for cooperating with the filter outlet 6 to form a radial seal connection.

Referring to FIG. 6, according to one embodiment of the present invention, a second sealing ring 19 is provided on an internal surface of one end of a safety filter element 13 for cooperating with the deflector 12 to form an axial seal connection.

Referring to FIG. 7, according to one embodiment of the present invention, a first sealing ring 18 is provided on one end surface of a safety filter element 13, and a second sealing ring 19 is provided on an internal surface of one end of a safety filter element 13. The first sealing ring 18 cooperates with the filter outlet 6 to form a radial seal connection, and the second sealing ring 19 cooperates with the deflector 12 to form an axial seal connection. The axial and radial seal connections prevent the air in the air channel 8 from leakage.

Referring to FIG. 2, according to one embodiment of the present invention, the dust discharge hole 10 is provided at a bottom of the shell 1.

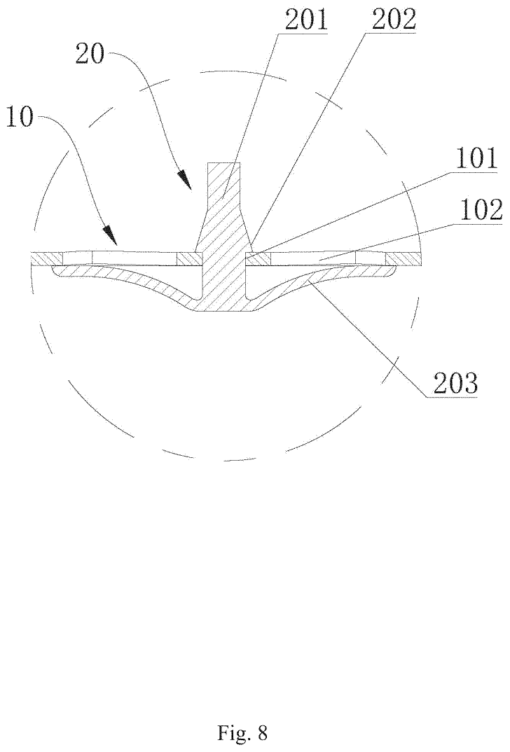

Referring to FIG. 8, a dust discharge valve 20 is provided in the dust discharge hole 10 on the external circumferential surface of the air filter end cap 3 and the dust discharge hole 10 at a bottom of the shell 1. The dust discharge valve 20 comprises an internal hole 101 and an external hole 102 provided outside the internal hole 101.

According to the embodiment, the external hole 102 comprises multiple holes arranged around and outside the internal hole 101.

The dust discharge valve 20 is made of an elastic material and further comprises a columnar portion 201 having a size matching the internal hole 101; a hook portion 202 is provided on the columnar portion 201, which restricts the columnar portion 201 after being inserted into the internal hole 101, thereby preventing the dust discharge valve from detaching; an umbrella cap portion 203 is connected to a tail end of the columnar portion 201, which covers the external hole 102. The dust discharge valve 20 discharges dust and water. When the engine normally intakes air, it is closed under a negative pressure. When the electromagnetic pulse valve is working to blow dust, it is opened under a positive pressure to discharge dust.

The air filter of the present invention uses the compressed air to blow the air to clean dust accumulated surface of the air filter element. The compressed air is stored in the air bag. The electromagnetic pulse valve is opened at a preset time and lasts for a preset period. The air is blown from the inside to the outside. According to an actual structure, a circle of dust discharge holes is arranged at the air filter end cap or the bottom of the circumferential surface of the shell, and a dust discharge valve is installed in the dust discharge hole to ensure that the dust will not leak from the dust discharge hole in a non-self-cleaning state. Only in a self-cleaning state, the dust will be discharged from the dust discharge hole under high-pressure air. When filter element needs to be replaced, a buckle or bolt structure can be opened to remove the air filter end cap, so as to replace the air filter element. As a result, a replacement cycle of the air filter element is significantly longer, and a replacement process is fast and convenient. The structure is simple, the filter element is easy to replace, and the self-cleaning structure is simple. High self-cleaning performance reduces the use cost of the entire air filter.

A control system of the above self-cleaning air filter is also provided, wherein a built-in air bag is connected to an on-board air tank or an independently driven compressor through a pipeline to be filled with compressed air. A volume of the air bag is generally 1 liter to 20 liters, preferably 2 liters to 5 liters, and ta pressure is 0.1 MPa to 1.0 MPa. A controller is electrically connected to the electromagnetic pulse valve, wherein the controller is also electrically connected to a vehicle battery and a trigger device; the vehicle battery is used for power supply, and the trigger device is used to provide a trigger signal for the electromagnetic pulse valve.

According to one embodiment of the present, the trigger device is a vehicle key ignition switch. The ignition switch provides the trigger signal for the electromagnetic pulse valve for the controller. When the controller detects a stop signal of the vehicle key ignition switch, the electromagnetic pulse valve will be triggered several times, typically 1 to 20 times, preferably 2 to 5 times. A blowing interval is 1 second to 600 seconds, typically 10 to 60 seconds. The controller may be a single-chip microcomputer AtMega328p.

According to one embodiment of the present, the trigger device comprises a vehicle key ignition switch and an air intake resistance sensor. The ignition switch provides the trigger signal for the electromagnetic pulse valve for the controller, and the air intake resistance sensor judges air intake resistance and provides the trigger signal for the electromagnetic pulse valve for the controller. The controller may be a single-chip microcomputer AtMega328p. When the controller detects a stop signal of the vehicle key ignition switch or the air intake resistance reaches a preset threshold, the electromagnetic pulse valve will be triggered several times, typically 1 to 20 times, preferably 2 to 5 times. A blowing interval is 1 second to 600 seconds, typically 10 to 60 seconds.

According to one embodiment of the present, the trigger device is a self-reset button switch and the controller is a relay. The electromagnetic pulse valve is connected to the vehicle battery and is controlled by the self-reset button switch. When cleaning is required, the electromagnetic pulse valve is triggered by manually pressing the self-reset button switch. The controller can be a relay or a time-delay relay.

The present invention provides a variety of control systems to control the air filter, wherein the electromagnetic pulse valve can be triggered by the vehicle key ignition switch or the intake resistance sensor or the self-reset button switch for self-cleaning, so as to automatically clean the accumulated dust in the filter element and the shell of the air filter. The present invention is easy to control and provides significant effect.

The above description of the disclosed embodiments enables those skilled in the art to implement or use the present invention. Various modifications to these embodiments will be apparent to those skilled in the art, and the general principles defined herein may be implemented in other embodiments without departing from the spirit or scope of the present invention. Therefore, the present invention will not be limited to the embodiments described herein, but shall conform to the widest scope consistent with the principles and novel features disclosed herein.

What is claimed is:

1. A self-cleaning air filter, comprising: a shell, wherein the shell is a cylindrical body with two opened ends; at least one air inlet is provided on an external circumferential surface of the shell; an air filter end cap is installed on a top cover at a first end in a length direction of the shell, and an air bag is fixed at a second end in the length direction of the shell; a filter outlet is provided inside the second end in the length direction of the shell; a main filter element is installed in the shell, wherein the main filter element is a ring-shaped filter element and is tightly installed in the shell through the air filter end cap; one end in a length direction of the main filter element presses against an external portion of the air bag to form a sealed connection; air enters from the air inlet to be filtered by the main filter element, and then is discharged from the filter outlet; a space between an external wall of the filter outlet and an internal wall of the shell forms an air channel; an air storage part of the air bag is arranged around the filter outlet; an output of the air storage part of the air bag is connected to an input end of an electromagnetic pulse valve, and an output end of the electromagnetic pulse valve communicates with an air inlet end of the air channel; an air outlet end of the air channel is located inside the main filter element; a dust discharge hole is provided on an external circumferential surface of the air filter end cap; compressed air stored in the air storage part of the air bag sequentially passes through the electromagnetic pulse valve and the air channel before being blown to the main filter element to remove dust on the main filter element and discharge the dust from the dust discharge hole.

2. The self-cleaning air filter, as recited in claim 1, wherein one side of the air inlet end of the air channel is provided with a guide groove corresponding to the output end of the electromagnetic pulse valve, to guide the compressed air in the air storage part of the air bag.

3. The self-cleaning air filter, as recited in claim 1, wherein a deflector is provided at the air outlet end of the air channel, and the deflector is arranged along a circumferential direction of the filter outlet.

4. The self-cleaning air filter, as recited in claim 3, wherein the deflector comprises an annular portion and an opening provided at a tail end of the annular portion; an included angle between the opening and the annular portion ranges from 0 degree to 80 degrees.

5. The self-cleaning air filter, as recited in claim 1, wherein a safety filter element is provided in the shell and located inside the main filter element; the safety filter element is a ring-shaped filter element and is tightly installed in the shell through the air filter end cap; an end in a length direction of the safety filter element, which is away from the air filter end cap, presses against the filter outlet to form a sealed connection.

6. The self-cleaning air filter, as recited in claim 1, wherein a safety filter element is provided in the shell and located inside the main filter element; the safety filter element is installed at an air inlet end of the filter outlet, wherein the safety filter element is a flat filter element matching the air inlet end of the filter outlet.

7. The self-cleaning air filter, as recited in claim 1, wherein a discharge valve is provided at a bottom of the air storage part of the air bag.

8. The self-cleaning air filter, as recited in claim 1, wherein an air inlet is provided at the air storage part of the air bag, and a valve is provided at the air inlet of the air bag.

9. The self-cleaning air filter, as recited in claim 8, wherein the valve is a differential pressure check valve.

10. The self-cleaning air filter, as recited in claim 1, wherein a first sealing ring is provided on one end surface of the main filter element for cooperating with an external surface of the air bag to form a radial seal connection.

11. The self-cleaning air filter, as recited in claim 1, wherein a second sealing ring is provided on an internal surface of one end of the main filter element for cooperating with an external bottom surface of the air bag to form an axial seal connection.

12. The self-cleaning air filter, as recited in claim 1, wherein a first sealing ring is provided on one end surface of a safety filter element for cooperating with the filter outlet to form a radial seal connection.

13. The self-cleaning air filter, as recited in claim 1, wherein a second sealing ring is provided on an internal surface of one end of a safety filter element for cooperating with a deflector to form an axial seal connection.

14. The self-cleaning air filter, as recited in claim 1, wherein the dust discharge hole is provided at a bottom of the shell.

15. The self-cleaning air filter, as recited in claim 1, wherein a dust discharge valve is provided in the dust discharge hole, which comprises an internal hole and an external hole provided outside the internal hole; the dust discharge valve is made of an elastic material; the dust discharge valve further comprises a columnar portion having a size matching the internal hole; a hook portion is provided on the columnar portion, which restricts the columnar portion after being inserted into the internal hole, thereby preventing the dust discharge valve from detaching; an umbrella cap portion is connected to a tail end of the columnar portion, which covers the external hole.

16. The self-cleaning air filter, as recited in claim 15, wherein the external hole comprises multiple holes arranged around and outside the internal hole.

17. The self-cleaning air filter, as recited in claim 1, wherein the shell is provided with an air inlet baffle facing the air inlet; the air inlet baffle is fixed on the shell by screws or rivets.

18. A control system of a self-cleaning air filter, comprising a controller which is electrically connected to an electromagnetic pulse valve, wherein the controller is also electrically connected to a vehicle battery and a trigger device; the vehicle battery is used for power supply, and the trigger device is used to provide a trigger signal for the electromagnetic pulse valve.

19. The control system, as recited in claim 18, wherein the trigger device comprises a vehicle key ignition switch.

20. The control system, as recited in claim 18, wherein the trigger device comprises an air intake resistance sensor, and the air intake resistance sensor is screwed into the filter outlet.

21. The control system, as recited in claim 18, wherein the trigger device comprises a self-reset button switch.

22. The control system, as recited in claim 18, wherein the controller is a single-chip microcomputer AtMega328p.

23. The control system, as recited in claim 18, wherein the controller is a relay.
